(19) United States
(12) Patent Application Publication
(10) Pub. No.: US 2014/0231355 A1
(43) Pub. Date: Aug. 21, 2014

(54) TREATMENT OF CONTAMINATED LIQUIDS

(71) Applicant: ARVIA TECHNOLOGY LIMITED, Chesire (GB)

(72) Inventors: Nigel Willis Brown, Staffordshire (GB); Edward P.L. Roberts, Calgary (CA); Nuria de las Heras-Rodriguez, Greater Manchester (GB)

(21) Appl. No.: 14/351,328

(22) PCT Filed: Oct. 9, 2012
(86) PCT No.: PCT/GB2012/052499

§ 371 Date: Apr. 11, 2014

(30) Foreign Application Priority Data
Oct. 11, 2011 (GB) 1117524.7

(51) Int. Cl. C02F 1/28

(52) U.S. Cl. CPC C02F 1/281
USPC 210/670; 210/243

(57) ABSTRACT

Apparatus and method for the treatment of a contaminated liquid to remove contaminants from said liquid. The apparatus comprises a bed of a carbon based adsorbent material capable of electrochemical regeneration, at least one pair of electrodes operable to pass an electric current through said bed to regenerate the adsorbent material, and means to admit contaminated liquid into said bed to contact said adsorbent material at a flow rate which is sufficiently high to pass the liquid through the bed but below the flow rate required to fluidise the bed of adsorbent material.

The present invention relates to methods and apparatus for the treatment of contaminated liquid by contact with an adsorbent material. It has particular, but not exclusive application in the treatment of liquids to remove organic pollutants.

Many methods have been developed to decontaminate liquids containing undesirable or unwanted species. Prior art methods typically exploit the process of absorption in which a contaminated liquid is contacted by a suitable absorbent material which has an affinity and capacity to absorb the contaminant from the bulk liquid phase into the pores of the absorbent material. Such a process is, however, only effective when the contaminant is present as a dispersed phase in the liquid. Absorption is not effective in the removal of dissolved contaminants from liquids.

An object of the present invention is to obviate or mitigate problems associated with existing methods and/or apparatus for treating contaminated liquids.

A first aspect of the present invention provides apparatus for the treatment of a contaminated liquid to remove contaminants from said liquid, the apparatus comprising a bed of a carbon based adsorbent material capable of electrochemical regeneration, at least one pair of electrodes operable to pass an electric current through said bed to regenerate the adsorbent material, and means to admit contaminated liquid into said bed to contact said adsorbent material at a flow rate which is sufficiently high to pass the liquid through the bed but below the flow rate required to fluidise the bed of adsorbent material.

According to a second aspect of the present invention there is provided a method for removing contaminants from a contaminated liquid, the method comprising admitting contaminated liquid into a bed of a carbon based adsorbent material capable of electrochemical regeneration at a flow rate which is sufficiently high to pass the liquid through the bed but below the flow rate required to fluidise the adsorbent material within the bed; and passing an electric current through the bed to regenerate adsorbent material that has adsorbed contaminants from the contaminated liquid.

In this way, controlling the flow rate of the contaminated liquid entering the adsorbent material bed so as to pass the liquid through the bed but ensure the adsorbent material remains within the bed for regeneration enables the adsorption and regeneration processes to be carried out simultaneously within the same bed of adsorbent material. It is therefore preferred to pass an electric current through the bed simultaneously with the admission of contaminated liquid through the bed. The adsorbent material can adsorb contaminants from the contaminated liquid whilst, within the same adsorbent bed, an applied electric current causes gaseous products derived from the adsorbed contaminant to be released from the adsorbent material thereby regenerating the adsorbent material and restoring its ability to adsorb further quantities of contaminant.

Contacting of the contaminated liquid with the adsorbent material may be achieved through controlled agitation of the adsorbent. Controlled agitation may be achieved by feeding one, or more preferably multiple, parallel jet streams of the contaminated liquid under pressure to the adsorption bed. Each individual stream of contaminated liquid will generate a cylindrical or funnel shaped passage of contaminated liquid through the adsorbent bed, drawing particulate adsorbent material from the lower region of the adsorbent bed and carrying it upward through the adsorbent bed. A downward flow of adsorbent material is produced around the upward flow of contaminated liquid and entrained adsorbent material thereby defining a discrete, endless stream of adsorbent material within the adsorbent bed flowing along an endless path.

During the upward passage of contaminated liquid and adsorbent material, the adsorbent material separates contaminants from the contaminated liquid by a process of adsorption whereby contaminants attach to the surfaces of the particles of the adsorbent material.

When the upward passage of contaminated liquid and particulate adsorbent is at the top of the adsorbent bed, the decontaminated liquid will cumulate or build-up in the liquid reservoir and the adsorbent material will remain within the adsorbent bed. The decontaminated liquid is free or substantially free of used adsorbent material and can then be released as desired via the outlet feed. The degree of decontamination of the liquid can be monitored by taking one or more samples of the accumulated liquid from the reservoir, and the liquid subjected to further treatment accordingly.

As the endless streams of adsorbent material are established in the adsorbent bed the electrodes are operated to pass an electric current through the adsorbent bed. The regions of adsorbent material flowing downwards possess a high enough packing (number of adsorbent particles per unit area) to be sufficiently electrically conductive to facilitate electrochemical regeneration of the adsorbent material. This oxidises the adsorbed contaminants releasing them in the form of carbonaceous gases and water thereby regenerating the adsorbent material and restoring its ability to adsorb further quantities of contaminant.

The electrodes preferably extend across the full height and width of the adsorbent bed to maximise their proximity to adsorbent particles loaded with contaminant in need of regeneration. The electrodes will typically be provided on opposite sides of the adsorbent bed. A plurality of electrodes may be disposed along each side. Alternatively, multiple electrodes may be installed horizontally to allow different currents to be applied at different heights across the adsorbent bed during operation. By way of example, at the top of the adsorbent bed the adsorbent material is fully loaded with adsorbed organics and so a larger current will be required than at the bottom of the adsorbent bed, where substantial regeneration of the adsorbent material will already have occurred.

In use, a voltage can be applied between the electrodes, either continuously or intermittently, to pass current through the adsorbent material and regenerate it in the manner described in “Electrochemical regeneration of a carbon-based adsorbent loaded with crystal violet dye”; N W Brown, E P L Roberts, A A Garforth and R A W Dryfe; Electrachemica Acta 49 (2004) 3269-3281 and “Atrazine removal using adsorption and electrochemical regeneration”; N W Brown, E P L Roberts, A Chasiotis, T Cherdron and N Sanghrajka; Water Research 39 (2004) 3067-3074.

The contaminated liquid must be contacted by the adsorbent material for a sufficient period of time to achieve satisfactory decontamination, i.e. transfer of contaminant from the liquid to the adsorbent material. Satisfactory decontamination time is ensured by controlling the velocity of the contaminated liquid through the adsorbent bed. This depends upon the initial velocity of the contaminated liquid injected into the tank and the packing and height of the adsorbent bed.

The maximum velocity of the contaminated liquid within the adsorbent bed is preferably just below the velocity that would cause fluidisation of the adsorbent particles. Fluidisation is produced when the velocity of the contaminated liquid is above the sedimentation rate of the adsorbent particles. The sedimentation rate of the adsorbent particles can be calculated according to Stokes's law and depends upon particle size, particle density and particle shape. The minimum velocity of the contaminated liquid is the velocity required to define an endless path along which the adsorbent material can flow within the adsorbent bed. Paths of adsorbent material are produced when the adsorbent bed is of a low enough packing to allow free movement of the adsorbent material. However, the efficiency of the adsorbent bed to undergo electrochemical regeneration depends upon a high packing of adsorbent material within the adsorbent bed. Thus, the velocity of the contaminated liquid through the adsorbent bed and the packing of the adsorbent bed are interdependent and each parameter should be optimised while taking into account the other parameter.

Optimal operational efficiency parameters of the present invention can be identified by the skilled person considering the adsorption and electrochemical oxidation characteristics of the organic to be treated. Treatment is usually either adsorption limited or electrochemical oxidation limited. For example, a liquid waste containing an organic contaminant that is easily adsorbed onto the adsorbent material but does not readily electrochemically oxidise will require a short contact time with the adsorbent material and a high current across the cell. By way of another example, a liquid waste containing an organic contaminant that is not easily adsorbed but readily electrochemically oxidises will require a long contact time with the adsorbent material and a low current across the cell.

It will be appreciated therefore that the design parameters and operational parameters of the present invention can be specifically selected to optimise the treatment efficiency for specific waste streams.

Removal of the treated liquid from the liquid reservoir may be effected in any convenient way. For example, one or more pumps may be used to cause the decontaminated liquid to flow out of the liquid reservoir for storage or any desirable further use. Alternatively or additionally, removal may be effected by control of valves or partitions in between the liquid reservoir and an adjacent vessel, such as a storage tank. For liquids originally containing particularly high levels of contamination, it may be desirable to pass some or all of the treated liquid from the liquid reservoir back through the adsorbent bed for further treatment. The need for doing so may be determined by reference to test samples of the treated liquid leaving the liquid reservoir. This could be used as a ‘fail-safe’ mechanism, which could be used, for example, during the initial stages of a treatment cycle at a new location or when treating a new source of contaminated liquid, or simply when a heavily contaminated liquid is to undergo treatment and it is particularly important that the resulting treated liquid is substantially free of the original contaminant for health and safety reasons.

By controlling the volume and the rate of the contaminated liquid allowed to flow into the adsorbent bed and the flow of liquid out of the liquid reservoir, it is possible to operate the method and apparatus of the present invention in a batchwise manner, a continuous manner or a semi-continuous manner.

It is desirable to have an optimum distribution of openings in the plate underneath the adsorbent bed, to allow for creation of a maximum number of discrete, endless streams of adsorbent material upon injection of contaminated liquid into the adsorbent bed. If the openings are too close together, the circuits will interfere and potentially disrupt each other, creating an unpredictable motion of adsorbent material or an accumulation of adsorbent material and contaminated liquid at the top of the adsorbent bed. If the openings are too far apart, adsorbent material in between the upward jets of contaminated liquid may become stagnant, resulting in wasted energy through passing current through part of the adsorbent bed without adsorbed contaminants. This could be eliminated by putting inert material (plastic) to replace any dead spots, which could be used as guides to direct the adsorbent material towards the openings in the plate.

One or more upright guides could be provided extending from the plate, said guides being provided in one or more linear arrays extending across the plate. In one embodiment the linear arrays extend equidistant from at least one opposing pair of walls defining the chamber. In another embodiment the linear arrays extend diagonally with respect to at least one opposing pair of walls defining the chamber.

Adsorbent materials suitable for use in the method of the present invention are solid materials capable of convenient separation from the liquid phase and electrochemical regeneration. Preferred adsorbent materials comprise adsorbent materials capable of electrochemical regeneration, such as unexpanded graphite intercalation compounds (UGICs) and/or activated carbon, preferably in powder or flake form. Typical individual UGIC particles suitable for use in the present invention have electrical conductivities in excess of 10,000 Ω⁻¹ cm⁻¹. It will be appreciated however that in a bed of particles of the adsorbent material this will be significantly lower as there will be resistance at the particle/particle boundary. Hence it is desirable to use as large a particle as possible to keep the resistance as low as possible. In addition the larger particles will settle faster allowing a higher flow rate to be achieved. However increasing the particle size will result in a reduction in the available surface area, so a balance is required over high settlement rates and low cell voltages against the reduction in adsorptive capacity from a reduction in surface area. It will be appreciated however that a large number of different UGIC materials have been manufactured and that different materials, having different adsorptive properties, can be selected to suit a particular application of the method of the present invention. The adsorbent material may consist only of UGICs, or a mixture of such graphite with one or more other adsorbent materials. Individual particles of the adsorbent material can themselves comprise a mixture of more than one adsorbent material. The kinetics of adsorption should be fast.

The capability of materials to undergo electrochemical regeneration will depend upon their electrical conductivity, surface chemistry, electrochemical activity, morphology, electrochemical corrosion characteristics and the complex interaction of these factors. A degree of electrical conductivity is necessary for electrochemical regeneration and a high electrical conductivity can be advantageous. Additionally, the kinetics of the electrochemical oxidation of the adsorbate must be fast. The kinetics depend upon the electrochemical activity of the adsorbent surface for the oxidation reactions that occur when the contaminant is destroyed. Additionally, electrochemical regeneration will generate very corrosive conditions at the adsorbent surface. The electrochemical corrosion rate of the adsorbent material under regeneration conditions should be low so that the adsorption performance does not deteriorate during repeated cycles of adsorption and regeneration. Additionally, some materials can passivate upon attempted electrochemical regeneration, often due to the formation of a surface layer of non-conducting material. This may occur, for example, as a result of the polymerisation of the contaminant, for example phenol, on the surface of the adsorbent. Additionally, electrochemical destruction of the contaminants on the adsorbent material will generate reaction products which must be transported away from the surface of the adsorbent material. The ability for the adsorbent material being regenerated to successfully transport the products away from the surface of the adsorbent material will depend upon both the surface structure and chemistry of the adsorbent material.

It will be appreciated that preferred adsorbent materials for the present invention will desirably have an ability to adsorb. The ability of the material to absorb is not essential, and in fact may be detrimental. The process of adsorption works by a molecular interaction between the contaminant and the surface of the adsorbent. By contrast, the process of absorption involves the collection and at least temporary retention of a contaminant within the pores of a material.

By way of example, expanded graphite is known to be a good absorber of a range of contaminants (e.g. up to 86 grams of oil can be ‘taken-up’ per gram of compound). UGICs have effectively no absorption capacity. They can adsorb, but the adsorption capacity is very low as the surface area is low (e.g. up to 7 milligrams of oil can be ‘taken-up’ per gram of compound). These figures demonstrate a difference of four orders of magnitude between the take-up capacity of expanded graphite and that of UGICs. The selection of UGICs for use in the present invention arises from carefully balancing its high regeneratability against its relatively low take-up capacity.

Apparatus for carrying out the process in a continuous, semi-continuous or batch-wise manner has been described previously in the following published International patent applications: WO2007/125334 and WO2009/050485 and WO2010/128298. Additionally, apparatus for carrying out the process specifically for disinfection purposes has been described previously in the following published International patent application: WO2011/058298.

It will be appreciated that the ability to decontaminate contaminated liquid whilst simultaneously regenerating adsorbent material loaded with adsorbed contaminant provides a method with significant improvements in terms of process flexibility and efficiency as compared to many prior art methods.

In prior art systems particle-particle abrasion results from vigorous contact between particles of the adsorbent material. Particle-particle abrasion is responsible for the breakdown of the adsorbent material and the production of fines. Breakdown of the adsorbent material has an impact upon the electrical conductivity of the adsorbent bed because larger particles produce greater electrochemical regeneration efficiencies. Additionally, fines are of a very small diameter and are difficult to remove from the decontaminated liquid. The reduced movement of the adsorbent particles in the method of the present invention in comparison to prior art methods, including those described in WO2007/125334 and WO2010/128298, provides a reduction in particle-particle abrasion and thereby minimises the associated problems.

Another advantage of the method of the present invention over the method described in WO2007/125334 is that the apparatus can have no internal obstacles, thus promoting free flow of the current of adsorbent material.

Another advantage of the method of the present invention over the method described in WO2007/125334 is that the electrodes can be much bigger, thus fewer cells are required to provide the same treatment efficiency. In the present invention, the regeneration zone can be the internal width of the entire treatment tank rather than a confined physical space defined within a larger treatment zone. An increase in the size of the electrodes will allow a greater current density across the adsorbent bed. In an alternative embodiment of the present invention, one large set of electrodes can be used to electrically regenerate more than one adsorbent bed at a time. The ability to stack multiple treatment zones in a series configuration facilitates greater treatment efficiency.

A further advantage of the method of the present invention is that it allows a treatment session to be selected for the particular contaminated liquid to be treated. The degree of decontamination of the liquid can be monitored, and the method adapted accordingly. It will also be appreciated that the relative sizes of the treatment zones can be varied according to the treatment required. The ability to modify the method and size of the treatment zone provides a process with significant flexibility.

Advantages of the method of the present invention over batchwise decontamination methods, including the methods described in the WO2010/128298, arise from the fact that adsorption and regeneration occur simultaneously and continuously in a single physical space, and that separation of the adsorbent material from the decontaminated liquid occurs automatically upon the ejection of liquid into the liquid reservoir. Consequently, the time taken to complete a treatment cycle, including adsorption, separation and regeneration steps, is substantially reduced compared to batchwise methods.

A further advantage is a reduction in the number of electrodes that are required compared with both batch and continuous systems. For the batch system this reduction occurs because the electrode is passing current all the time whereas in sequential batch operation for a large part of the time the system is adsorbing and settling so the electrodes are not being used resulting in a larger number being required. In the treatment of raw waters using the sequential batch process the regeneration period can be as little as 10% of the operational time. Compared to the continuous process referred to in WO2007/125334 the reduction in electrodes is due to the fact that there is a maximum size of electrode that can be used and above this size multiple electrodes must be installed, undesirably increasing unit size, cost and complexity.

The ability to simultaneously contact the adsorbent material with contaminated liquid and regenerate the adsorbent material within the same zone allows a significant reduction in the physical size of the tank, affording a compact and potentially mobile apparatus. Conversely, in an alternative embodiment of the invention, greater treatment efficiencies can be obtained by using a larger tank because it can accommodate a much larger treatment zone in comparison to the apparatus described in WO2007/125334 and WO2010/128298.

Another advantage of the method of the present invention over prior methods of treatment, such as those described in WO2010/128298, is that the distance between the electrodes can be smaller. Regeneration efficiency is highest at the membrane of the cathode and decreases with distance toward the anode. Decreasing the distance between the cathode and anode will allow regeneration of the adsorbent material as quickly as possible, using as little power as possible because the cell voltage will be lower and/or restoration of as higher percentage as possible of the original adsorptive capacity of the adsorbent material.

An advantage of the apparatus of the present invention over prior art methods of disinfection, such as that described in WO2011/058298, is that the water to be treated passes directly between the electrodes. The direct production of secondary oxidising species within the contaminated liquid as a consequence of secondary electrochemical reactions provides additional disinfection of the contaminated liquid. It is therefore preferred that passage of the electrical current through the bed is effected so as to produce secondary oxidising species within the contaminated liquid in order to provide additional disinfection

The invention will now be described by way of example and with reference to the accompanying schematic drawings wherein:

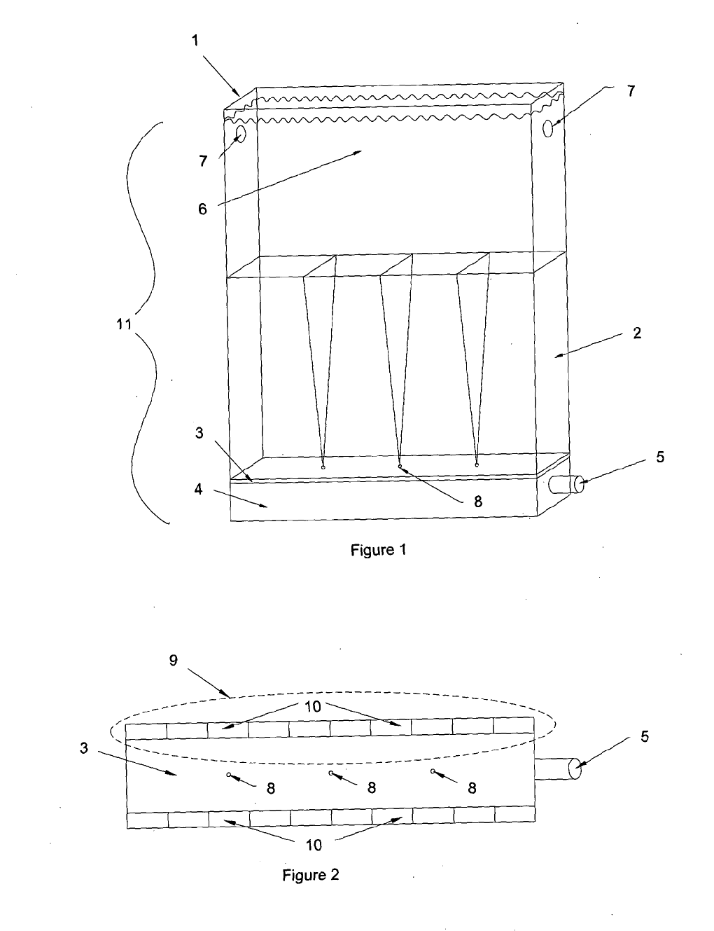

FIG. 1 is a schematic perspective view of apparatus according to an embodiment of the present invention;

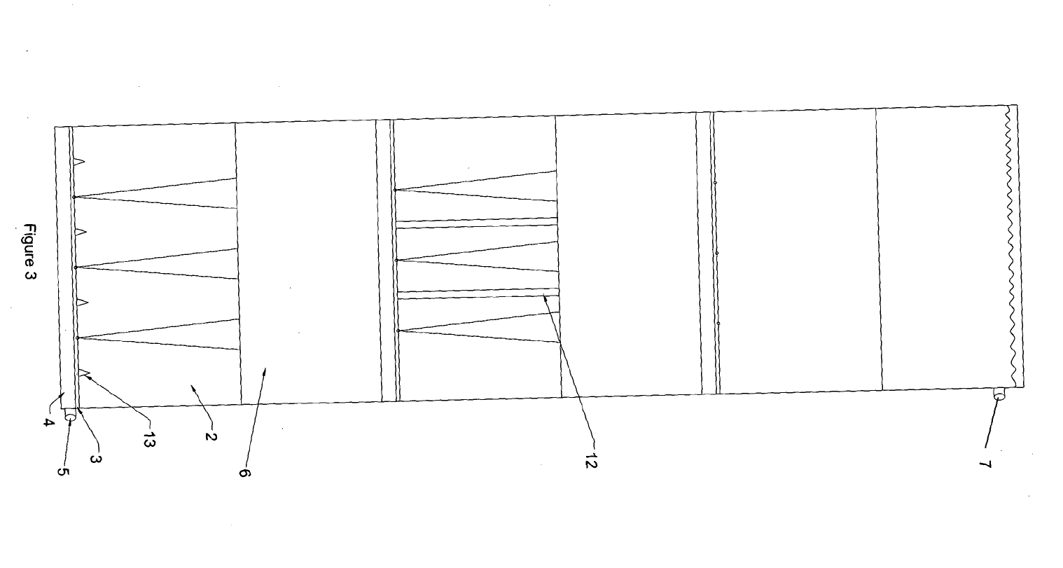

FIG. 2 is a horizontal cross-sectional view of a lower section of the apparatus shown in FIG. 1;

FIG. 3 is a schematic side view of a further embodiment of the present invention including multiple stacked treatment zones;

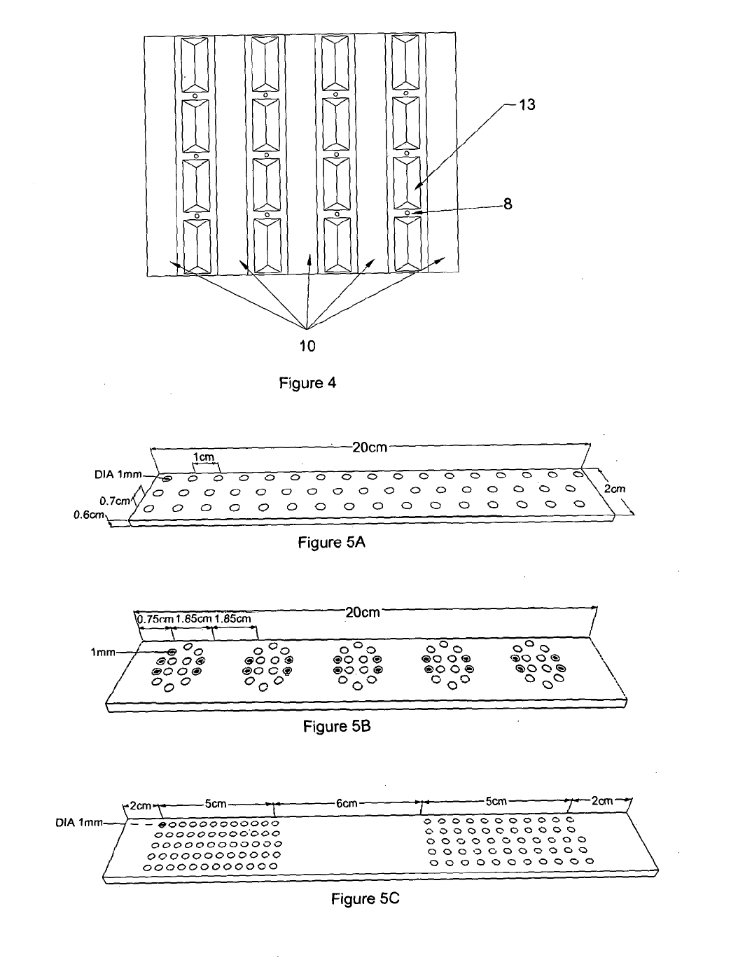

FIG. 4 is a top plan view of an alternative base of the reservoir of FIG. 1, showing an alternative arrangement of regeneration electrodes;

FIGS. 5 A-C are schematic illustrations of different embodiments of a plate through which the liquid is admitted into the treatment zones;

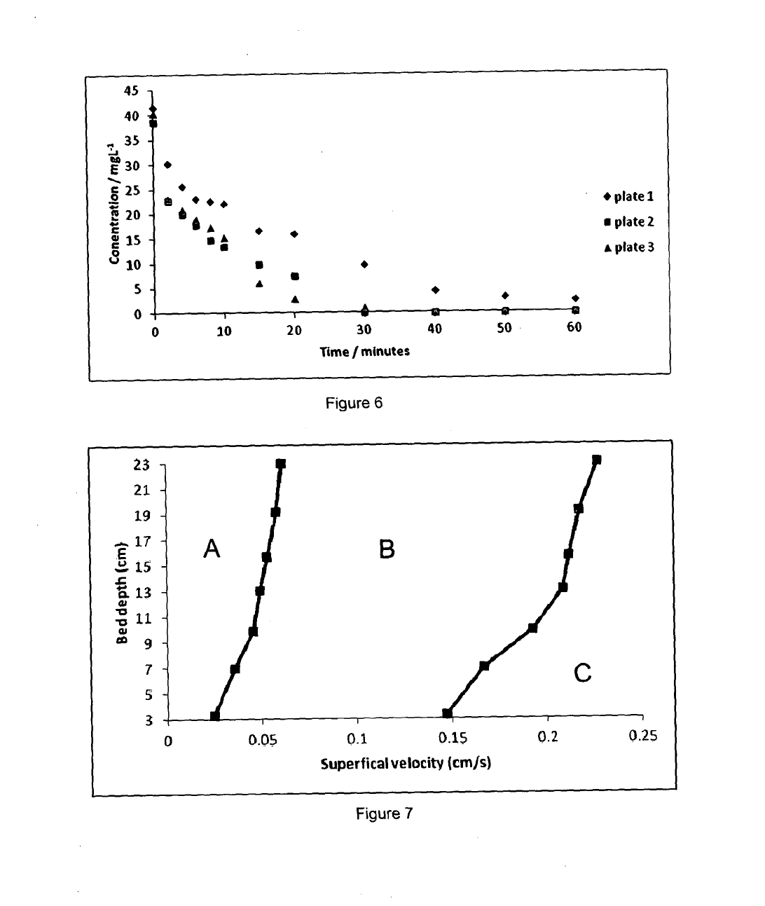

FIG. 6 is a graph showing the decrease in contaminant concentration with time achieved using apparatus according to a preferred embodiment of the present invention; and

FIG. 7 is a graph showing the variation in superficial velocity of liquid admitted into an adsorbent bed (feed flow rate divided by cross sectional area of the bed) as a function of varying bed depth.

FIG. 1 illustrates a simple tank 1 of rectangular horizontal cross section. In the lower section of the tank 1 a bed of particulate adsorbent material 2 is supported on a plate 3. Beneath the plate 3 is a chamber 4 for receiving a fluidising medium (not shown), such as a contaminated liquid, from an inlet feed 5. Above the bed of adsorbent material 2 is a liquid reservoir 6. An additional liquid reservoir can be housed in a separate compartment (not shown). Outlet feeds 7 are provided towards the top of the liquid reservoir 6. The plate 3 defines three equally spaced openings 8 through which the contaminated liquid can be admitted into the bed of adsorbent material 2 from the chamber 4. Any desirable number of openings 8 may be used, of any desirable size and/or shape. They may be generally circular as illustrated, or they may have a different cross-sectional profile, for example, elliptical, rectangular or square. Moreover, the openings 8 may all be of the same size and shape, or they may vary from one to another. Furthermore, one or more of the circular openings 8 may be replaced with a plurality of smaller openings grouped or clustered together to define an array of small openings. Electrodes required for regeneration of the adsorbent material after it has contacted the contaminated liquid are omitted from FIG. 1 for clarity but are described below with reference to FIG. 2.

FIG. 2 is a horizontal cross-sectional view of a lower section of the tank 1 showing the plate 3 and the openings 8 in greater detail. Also shown in FIG. 2 are two banks 9 of electrodes 10 which extend along opposite longer sides of the plate 3 and extend upwardly therefrom to the top of the bed of adsorbent material 2 beneath the liquid reservoir 6. The bed of adsorbent material 2 is supported on the plate 3 within the walls of the tank 1, between the banks 9 of electrodes 10. The apparatus 2 to 10 as described constitute a treatment zone 11.

The banks of electrodes 10 are operable to pass an electric current through material present in between the electrodes. The cathode will normally be housed in a separate compartment (not shown) defined by a porous membrane or filter cloth to protect it from direct contact with the adsorbent material. A porous membrane enables a catholyte, which can be sodium chloride/sulphate or any other salt which will provide conductivity, to be pumped through the compartment, serving both to provide a means for controlling the pH level and as a coolant for removing heat generated during the passage of an electric current through the adsorbent material. The catholyte also provides conductivity between the cathode and the membrane ensuring low cell voltages.

The adsorbent material used in the practice of the present invention is carbon based and provided in particulate form.

In use, contaminated liquid is delivered to the chamber 4 via the inlet pipe 5. The contaminated liquid is under sufficient pressure that it will enter the adsorbent bed 2 through openings 8. The openings 8 are far enough apart to ensure that there is no general flow of liquid up through the adsorbent bed 2, but rather that a generally columnar or, more specifically funnel-like, uplift of liquid is established within the adsorbent bed 2 from each opening 8 which entrains particulate adsorbent material. This funnel-like behaviour of the contaminated liquid and entrained adsorbent is illustrated schematically in FIG. 1 as a triangle emanating from each opening 8. The spacing of the openings 8 should be chosen to ensure that each funnel of rising liquid and entrained adsorbent does not interfere with neighbouring funnels to any significant extent. There must also be sufficient space between the openings 8 to ensure that the funnels of rising liquid and entrained adsorbent are far enough apart to allow the adsorbent particles to drop down through the adsorbent bed 2 under gravity after reaching the top of the adsorbent bed 2. Example 1 below presents the results of an initial set of experiments to investigate three different arrangements of plate openings 8. All three arrangements worked satisfactorily but it was observed that a plate defining three parallel rows of openings 1 mm in diameter, spaced apart by 1 cm parallel to the longitudinal axis of the plate and 0.7 cm perpendicular to the longitudinal axis in the plane of the plate (See FIG. 5A) performed least well. The arrangement of plate openings that performed next best consisted of five circular clusters of 1 mm diameter openings, with 14 openings in each cluster (See FIG. 5B). The distance between each cluster parallel to the longitudinal axis of the plate was 1.85 cm. Some of the outer openings in each cluster were drilled at a 60° angle in the direction of the region between the clusters to try to encourage the formation of discrete streams of contaminated liquid and entrained adsorbent material within the adsorbent bed. Notwithstanding the attempt to improve performance by drilling angled openings in the plate shown in FIG. 5B, the best performing arrangement of openings according to this preliminary investigation was a plate defining two rectangular clusters of 1 mm diameter openings with 55 openings in each cluster (See FIG. 5C). Within each cluster, the openings were spaced 0.5 cm apart from one another parallel and perpendicular to the longitudinal axis of the plate and in the plane of the plate. The length of each rectangular cluster measured along the longitudinal axis of the plate was 5 cm and the two rectangular clusters were separated by a distance of 6 cm along the longitudinal axis of the plate. From these preliminary tests it therefore seems that it is desirable to have discrete, spaced clusters containing multiple openings, and to space the clusters apart by approximately the same distance as the width of each cluster.

The uplift of liquid pushes the adsorbent particles within the adsorbent bed 2 further apart producing a localised expanded bed of adsorbent particles associated with each opening 8. During this upward movement of the contaminated liquid and the adsorbent material, the adsorbent material separates contaminants from the contaminated liquid by a process of adsorption whereby contaminants attach to the surfaces of the particles of the adsorbent material.

When the passages of contaminated liquid and particulate adsorbent reach the top of the adsorbent bed 2, the decontaminated liquid will accumulate in the reservoir 6. The flow rate of the contaminated liquid passing through the openings 8 into the adsorbent bed 2 is controlled so that it is below the rate required to cause fluidisation of the adsorbent particles. As a result, the adsorbent material at the top of the adsorbent bed 2 remains in the adsorbent bed 2 and flows downwards around the funnel-like upward flow of contaminated liquid and adsorbent material. The downward flow of adsorbent particles is further aided by the positioning of the openings 8 at the bottom of the adsorbent bed 2 because the ingress of the contaminated liquid entrains adsorbent particles in the vicinity of the openings 8, i.e. towards the bottom of the adsorbent bed 2. In this way multiple, discrete endless paths for adsorbent material are established within the adsorbent bed 2. This is a fundamental and important difference between this invention and prior art systems. Rather than establishing only a single endless path for the adsorbent material between a pair of electrodes within a tank, the present invention provides a relatively simple and convenient means for establishing any desirable number of endless paths along which adsorption, separation and regeneration can take place within a single tank.

Preliminary tests presented below have demonstrated that an inlet flow rate for the contaminated liquid of around 30 to 60 Uh may be preferred, more particularly, that a flow rate of around 30 to 50 L/h may be preferred. Based on the preliminary tests described below in Example 2, an inlet flow rate of around 38 L/h is preferred. In Example 2, the affect of altering the height of the adsorbent bed was also investigated. The height of the bed is directly proportional to the length of time the contaminant liquid is contacted with the adsorbent material and so it is currently envisaged that a greater height of adsorbent bed is desirable to maximise the efficiency of the decontamination process in a single pass through the adsorbent bed. The results of these initial tests suggest that it may be desirable to use an adsorbent bed having a height of around 10 to 20 cm, and that around 15 cm is preferred.

Once the adsorbent material reaches the top of the adsorbent bed 2 it is loaded with adsorbed contaminant which needs regenerating as it drops down towards the bottom of the adsorbent bed 2. While the adsorbent material is passing along the endless paths established within the adsorbent bed 2, the electrodes 10 are operated to pass an electric current through the adsorbent bed 2. The more conductive sections of the adsorbent bed 2 are those regions having a higher packing of the adsorbent material. Since the higher packed regions are those in which the loaded adsorbent material is flowing downwards through the adsorbent bed 2 the regenerative electric current flows through the regions of the adsorbent bed 2 where it is most needed. Electrochemical regeneration of the adsorbent particles releases the adsorbed contaminants in the form of carbonaceous gases and water. The gases are released either through the open top of the tank 1, or if the tank is closed, through a suitable valve or port (not shown), optionally for subsequent treatment.

The decontaminated liquid in the liquid reservoir 6 is free or substantially free of used adsorbent material and can then be released as desired via the outlet feed 7. Alternatively, the liquid can be fed from the outlet feed 7 back into the inlet feed 5 for further decontamination if required. The movement of the decontaminated liquid from the liquid reservoir 6 to an optional additional liquid reservoir (not shown) can be effected by controlling the depth of liquid within the liquid reservoir 6 so that its surface is periodically higher than an upper edge of a dividing wall between the liquid reservoir 6 and the additional liquid reservoir. In this way, treated liquid periodically flows over the upper edge of the dividing wall into the additional liquid reservoir.

The length of time for which the contaminated liquid is contacted with the adsorbent material can be controlled by adjusting the rate of the flow of contaminated liquid. Alternatively or additionally, the contact time can be controlled by adjusting the height of the adsorbent bed. Thus variations in the concentration of contaminant in the contaminated liquid can be catered for.

There are a number of different operating parameters of the system described above which need to be carefully controlled to ensure the process operates efficiently. For example, the adsorbent bed 2 should possess a packing which is low enough to enable the discrete endless paths for adsorbent material to be established, but high enough to ensure that it settles to form a higher solids content region which can exhibit a high enough conductivity for efficient electrochemical regeneration to be achieved across the depth of the adsorbent bed 2 used. A related factor is the initial injection velocity of the contaminated liquid, which should be high enough to enable the discrete endless paths for adsorbent material to be established, but not so high as to fluidise the adsorbent material into the liquid reservoir 6.

FIG. 3 illustrates a further embodiment of the present invention in which a plurality of treatment chambers 11A, 11B, 11C are stacked in a series arrangement within a single tank 1. The same reference numerals will be used in FIG. 3 for components corresponding to those described above in relation to FIGS. 1 and 2. Extending upwardly along the opposite longer sides of the tank 1 are two banks 9 of electrodes 10 (not shown) with a similar general arrangement to that shown in FIG. 2. This arrangement allows multiple treatment cycles to be carried out while using the same number of electrodes 10 as the embodiment shown in FIGS. 1 and 2, the only difference being that the electrodes 10 need to be of a larger size. Additional preferred features of the apparatus of the present invention shown in FIG. 3 are dividers 12 located in between holes 8 which extend upwardly from plate 3 to the top of the adsorbent bed 2. The dividers 12 are intended to minimise interference between neighbouring endless paths for adsorbent material. Also illustrated schematically in FIG. 3 are guides 13 located in between holes 8 which extend upwardly from plate 3 but which extend only part way into the adsorbent bed 2. The guides 13 may be provided with any appropriate size, shape and/or positioning within the unit, to encourage the optimum flow of the adsorbent material from the plate 3 upwards through the adsorbent bed 2. For example the guides 13 may be provided diagonally across the electrochemical cell, providing a baffle function within the adsorbent bed.

FIG. 4 illustrates another embodiment of the invention in which a multiplicity of electrodes 10 can be closely aligned in a cell in a parallel arrangement. Application of a voltage across the outer electrodes polarises the intermediate electrodes, so effectively a series of alternate cathodes and anodes are present between the outermost cathode and anode. The use of bipolar electrodes in this way facilitates one current to be generated a number of times with a proportional increase in voltage. This has the advantage of increasing the voltage to obtain a larger current in the adsorbent material in sections of the bed between the electrodes than would be achieved by the simple application of a larger voltage across the bed as a whole. The distance between the electrodes can optimally be from about 15 mm, up to about 25 mm; this is sufficient to allow cell voltage to be kept at an acceptable level, without creating blockages of the adsorbent material, and to allow the released contaminants to escape in the form of bubbles. FIG. 4 also shows an exemplary arrangement of alternating openings 8 and guides 13 designed to optimise the flow of contaminated liquid into the adsorbent bed to maximise operational efficiency.

### EXAMPLES

### Example 1

An experiment was conducted to observe the performance of three different embodiments of the apparatus of the present invention according to the distribution of openings in the inlet plate. These are described as Plate 1, Plate 2 and Plate 3 below.

The model contaminated liquid used for the experiment was aqueous Acid Violet 17. The pore diameter used for the openings defined by the inlet plates was 1 mm.

### Plate 1

The plate defined a plurality of openings having the following characteristics.

Three parallel rows of openings. The distance between each opening was 1 cm parallel to the longitudinal axis of the plate and 0.7 cm perpendicular to the longitudinal axis in the plane of the plate.

### Plate 2

The plate defined a plurality of openings having the following characteristics.

Five circular clusters of openings. The number of openings in each cluster was 14. The distance between each circular zone parallel to the longitudinal axis of the plate was 1.85 cm.

Four of the outer openings (marked black in FIG. 5B) were drilled at a 60° angle in the direction of the region between the circular zones so as to encourage the formation of discrete streams of contaminated liquid and entrained adsorbent material within the adsorbent bed.

### Plate 3

The plate defined a plurality of openings having the following characteristics.

Two rectangular clusters of openings with 55 openings in each cluster. The distance between each opening parallel and perpendicular to the longitudinal axis of the plate was 0.5 cm in the plane of the plate. The length of each rectangular cluster measured along the longitudinal axis of the plate was 5 cm and the two rectangular clusters were separated by a distance of 6 cm along the longitudinal axis of the plate.

The decrease in contaminant concentration with time was monitored for apparatus according to the present invention containing each of the three types of plate. The results are presented below in FIG. 6.

The voltage and flow rates were monitored during treatment. The results are presented below in Table 1.

TABLE 1

| Plate | Voltage (V) | Current (A) | Flow rate (ml s⁻¹) |
|---|---|---|---|
| Plate 1 | 4.5-5.2 | 0.1 | 4.5-5 |
| Plate 2 | 5.0-5.8 | 0.1 | 4.5-6 |
| Plate 3 | 4.3-5.2 | 0.1 | 4.5-6 |

As can be seen from the results presented in FIG. 6 and Table 1, all three plate configurations provided a good reduction in the level of contamination in the liquid under test over a reasonable period of time. Plates 2 and 3 decontaminated the liquid more quickly than Plate 1, while Plate 3 provided an improvement as compared to Plate 2 in terms of the voltage required to obtain a current of 0.1 A.

### Example 2

A preliminary experiment was conducted to investigate the performance of the apparatus and method of the present invention according to the height of the adsorbent bed and the flow rate of the contaminated liquid.

The model liquid used for the experiment was water because the behaviour of the adsorbent material, and not the removal of contaminants, was under observation.

The behaviour of the adsorbent material was monitored at different flow rates and different heights of adsorbent bed. The results are presented below in Table 2.

The apparatus used for the present example had a height of 79 cm, a width of 29 cm, a depth of 2.2 cm and a total capacity of 5.5 L.

TABLE 2

| | Fluidisation of adsorbent | | | Streams of liquid and entrained | | |
|---|---|---|---|---|---|---|
| Flow | material observed? | | | adsorbent visible in adsorbent bed? | | |
| rate | 500 g | 750 g | 1000 g | 500 g | 750 g | 1000 g |
| (L/h) | (10 cm) | (15 cm) | (20 cm) | (10 cm) | (15 cm) | (20 cm) |
| 11 | No | No | No | No | No | No |
| 26 | No | No | No | No | No | No |
| 38 | No | No | No | Some | Yes | Some |
| 53 | No | Yes | No | Some | Yes | Some |
| 60 | Yes | Yes | — | Yes | Yes | — |
| 81 | Yes | Yes | — | Yes | Yes | — |
| 82 | Yes | — | — | Yes | Yes | — |

“—”: operating conditions which prevented the apparatus from operating satisfactorily.

The optimum flow rate for the contaminated liquid is that which does not cause the adsorbent material to become fluidised in the liquid reservoir but does allow streams of liquid and entrained adsorbent material to form in the adsorbent bed. The height of the adsorbent bed is directly proportional to the length of time the contaminant liquid is contacted with the adsorbent material. Therefore a greater height of adsorbent bed is desirable to achieve maximum efficiency of treatment in a single pass through the adsorbent bed. As can be seen from the results presented in Table 2, the results of this preliminary investigation suggest that for a 5.5 L capacity tank with the dimensions mentioned above, an optimum flow rate for the contaminated liquid is around 38 l/h with an adsorbent bed 15 cm in height.

### Example 3

An experiment was conducted to investigate optimal design and operational parameters by considering the adsorption and electrochemical oxidation characteristics of a model contaminated liquid.

The model liquid used for the experiment was an aqueous solution of Acid Violet 17 dye of a concentration of 500 ppm.

The adsorption characteristics of the model liquid were investigated by measuring the outlet concentration, i.e. the amount removed, of Acid Violet 17 dye as a function of mass of adsorbent in the adsorbent bed (240 g, 480 g, 840 g and 1200 g).

The electrochemical oxidation characteristics of the model liquid were investigated by measuring the outlet concentration of the Acid Violet 17 dye as a function of electric current passed across the electrochemical cell (1 A and 2 A).

The apparatus used for the present example was similar to the apparatus used for Example 2.

TABLE 3

Steady state outlet concentration of
Acid Violet 17 dye/ppm

| Mass of | Current passed | Current passed |
|---|---|---|
| adsorbent | across the cell | across the cell |
| (g) | 1 A | 2 A |
| 240 | 320 | 280 |
| 480 | 157 | 180 |
| 840 | 160 | 150 |
| 1200 | 120 | 100 |

“-”: adsorption and electrochemical oxidation characteristics of a model liquid containing an inlet Acid Violet 17 dye concentration of 500 ppm.

The efficiency of treatment is indicated by the steady state outlet concentration of the Acid Violet 17 dye. As can be seen from the results presented in Table 3, the outlet concentration notably decreases, i.e. the amount of dye removed from the contaminant liquid increases, when the mass of adsorbent is increased. However, the outlet concentration does not proportionately decrease when the current passed across the cell is increased by 100%. This indicates that the treatment of a liquid containing Acid Violet 17 dye is limited by the adsorption characteristics of the organic contaminant, rather than the electrochemical oxidation characteristics. It will be appreciated, therefore, that the optimal design and operational parameters for treatment of the model liquid will accommodate for a large mass of adsorbent material in the cell and a low current across the cell.

### Example 4

Adsorbent bed movement was monitored at different superficial velocities (as measured by feed flow rate divided by cross sectional area of the bed) for a variety of bed heights, the results are presented below in FIG. 7.

The region labelled ‘B’ indicates the superficial velocities at which adsorbent bed movement was optimal. Flow rate in this region has low flow pressure drop and short liquid residence time, with regeneration predominantly taking place in the packed bed zones and adsorption predominantly taking place in the spouting (liquid jet) regions. These superficial velocities minimise the opportunity for undesirable intermediate breakdown products being released in the treated effluent.

The region labelled ‘A’ indicates the superficial velocities at which the adsorbent bed movement was sub-optimal. Flow rate in this region has high flow pressure drop and long liquid residence time, with regeneration and adsorption occurring throughout the bed. These superficial velocities could lead to formation of undesirable breakdown products.

The region on the graph labelled ‘C’ also indicates the superficial velocities at which the adsorbent bed movement was sub-optimal. Non-continuous contact between the adsorbent bed particles and the electrodes necessitates a high cell voltage, with a lower efficiency of electrochemical regeneration being achieved.

FIG. 7 indicates that the optimum superficial velocity for treatment using bed depths of 3 cm-23 cm is 0.10 cm/s to 0.15 cm/s.

The bed was composed of particles having a flake-like shape (similar to that associated with a graphite precursor), a carbon content of ˜95 wt %, a typical particle diameter of 360-500 μm, with particle diameters ranging between 100-700 μm in size. The Brunauer Emmett Teller (BET) surface area as determined by nitrogen adsorption was found to be 1.0 m² g⁻¹.

### Comparative Example

An experiment was conducted to compare the performance of the apparatus and method according to the present invention to the liquid decontamination apparatus and method described in WO2007/125334.

The model contaminated liquid used for the experiment was aqueous Acid Violet 17.

The capacity parameters for the two systems are set out below:

| Capacity parameters | WO2007/125334 | Present Invention |
|---|---|---|
| Internal volume (L) | 9 | 2 |
| Electrode area (cm²) | 720 | 100 |
| Mass of Nyex (kg) | 2.5 | 0.14 |

The rate at which decontamination was achieved was calculated for each system.

This was operated as a continuous single pass treatment with a continuous flow of liquid into and out of the treatment apparatus.

Treatment rate=flow rate×(Δ concentration)

Flow rate=0.33 L/min
Concentration in=52.2 ppm
Concentration out=0.1 ppm

Treatment rate=0.33×(52.2−0.1)=17.2 mg/min

### Present Invention

This was operated as a non-continuous single pass treatment with a single volume of contaminated liquid passed through the treatment apparatus, rather than a continuous flow as in the WO2007/125334 system.

Treatment rate=volume treated×(Δ concentration/time of treatment)

Flow rate=26 ml/s (1.6 L/min)
Solution volume treated=4 L
Concentration in=40 ppm
Concentration after 30 minutes=0 ppm

Treatment rate=4×(40/30)=5.3 mg/min

### Normalisation

Normalised treatment rates were calculated for the conventional system and the system of the present invention by dividing the appropriate treatment rate by the respective capacity parameters. The results are presented below in Table 4.

| | Normalised Treatment Rate | |
|---|---|---|
| Parameter Used To Calculate | Conventional | Present |
| Normalised Rate | System | Invention |
| Internal Volume (rate in mg/(min L)) | 1.9 | 2.7 |
| Electrode area (rate mg/(min cm²)) | 0.024 | 0.053 |
| Mass of Nyex (rate mg/(min kg)) | 6.9 | 38 |

As can be seen from the above results, the system according to the present invention provided a significant improvement as compared to the conventional system in terms of normalised treatment rate whether based on internal volume, electrode area or the mass of adsorbent used.

In the method and apparatus of the present invention adsorption and regeneration phases, which have conventionally been separate, have been combined, and the separation phase completely eliminated. As a result, a typical treatment cycle of adsorption (5 minutes), separation (2 minutes) and regeneration (5 minutes) phases that might have taken around 12 minutes will now take only around 5 minutes. This simultaneous adsorption and regeneration process will occur regardless of batch or flow of liquid through the treatment system. Further advantages over the process described in WO2007/125334 arise from a reduction in particle-particle abrasion and the use of the contaminated liquid rather than air for fluidisation. The improvements noted above over the WO2007/125334 system, which itself represented a significant improvement to earlier decontamination systems, are even more impressive by virtue of the fact that they were obtained using a scale model of the anticipated commercial system with a relatively small electrode only 5 cm in height. As a result, it was not considered feasible to achieve a high level of decontamination in a single pass of liquid through the adsorbent bed.

1-27. (canceled)

28. Apparatus for the treatment of a contaminated liquid to remove contaminants from said liquid, the apparatus comprising a bed of a carbon based adsorbent material capable of electrochemical regeneration, at least one pair of electrodes operable to pass an electric current through said bed to regenerate the adsorbent material, and means to admit contaminated liquid into said bed to contact said adsorbent material at a flow rate which is sufficiently high to pass the liquid through the bed but below the flow rate required to fluidise the bed of adsorbent material.

29. Apparatus according to claim 28, wherein the apparatus comprises one or more spaced inlets through which the contaminated liquid is admitted under pressure into the bed of adsorbent material.

30. Apparatus according to claim 29, wherein the apparatus comprises a plurality of said inlets spaced apart by a sufficient distance to establish a corresponding plurality of discrete liquid flow paths through the adsorbent bed.

31. Apparatus according to claim 30, wherein the spacing of the plurality of inlets is sufficient to define a region around each liquid flow path through which adsorbent material that has adsorbed contaminant can flow so as to define a discrete, endless stream of adsorbent material within the bed of adsorbent material.

32. Apparatus according to claim 29, wherein the inlets are defined by a plate which supports the bed of adsorbent material.

33. Apparatus according to claim 32, wherein the apparatus further comprises a chamber underneath said plate to hold the contaminated liquid prior to being admitted through the inlets into the bed of adsorbent material.

34. Apparatus according to claim 33 further comprising one or more upright guides extending from the plate, said guides provided in one or more linear arrays extending across the plate.

35. Apparatus according to claim 28, wherein the apparatus comprises a reservoir in fluid communication with the adsorbent bed, the reservoir being adapted to receive liquid from the bed which has been contacted by the adsorbent material.

36. Apparatus according to claim 35, wherein means is provided to determine a level of residual contamination of the liquid in said reservoir and to pass said liquid back to the bed of adsorbent material for further treatment if the level of contamination is above a threshold value.

37. Apparatus according to claim 28, wherein the carbon based adsorbent material is an unexpanded graphite intercalation compound and/or activated carbon.

38. Apparatus according to claim 28 which is configured to produce secondary oxidising species within the contaminated liquid to effect additional disinfection.

39. A method for removing contaminants from a contaminated liquid, the method comprising admitting contaminated liquid into a bed of a carbon based adsorbent material capable of electrochemical regeneration at a flow rate which is sufficiently high to pass the liquid through the bed but below the flow rate required to fluidise the adsorbent material within the bed; and passing an electric current through the bed to regenerate adsorbent material that has adsorbed contaminants from the contaminated liquid.

40. A method according to claim 39, wherein the contaminated liquid is admitted under pressure through one or more inlets into the bed of adsorbent material.

41. A method according to claim 40, wherein the contaminated liquid is admitted through a plurality of said inlets spaced apart by a sufficient distance to establish a corresponding plurality of discrete liquid flow paths through the adsorbent bed.

42. A method according to claim 41, wherein the spacing of the plurality of inlets is sufficient to define a region around each liquid flow path through which adsorbent material that has adsorbed contaminant can flow so as to define a discrete, endless stream of adsorbent material within the adsorbent bed.

43. A method according to claim 42, wherein the liquid from the bed adsorbent material which has been contacted by the adsorbent material is passed to a reservoir in fluid communication with the bed adsorbent material.

44. A method according to claim 43, wherein a level of contamination of the liquid in said reservoir is calculated and compared to a threshold value to determine whether to pass said liquid back to the bed of adsorbent material for further treatment.

45. A method according to claim 39, wherein a plurality of electrodes are operable to apply different currents across different regions of the bed of adsorbent material.

46. A method according to claim 39, wherein the electric current is passed through the bed simultaneously with admission of contaminated liquid into the bed.

47. A method according to claim 39 wherein passage of the electrical current through the bed is effected so as to produce secondary oxidising species within the contaminated liquid to provide additional disinfection.
